(19) United States
(12) Patent Application Publication
(10) Pub. No.: US 2009/0285445 A1
(43) Pub. Date: Nov. 19, 2009

(54) System and Method of Translating Road Signs

(75) Inventor: Yojak Harshad Vasa, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/137,095

(22) Filed: Jun. 11, 2008

Related U.S. Application Data
(60) Provisional application No. 61/053,333, filed on May 15, 2008.

(51) Int. Cl. G06K 9/00; H04M 1/00

(52) U.S. Cl. 382/100; 455/556.1

(57) ABSTRACT

A camera-equipped wireless communication device captures images of traffic signs that are unfamiliar to a user. A controller in the device analyzes the captured image and generates information that allows the user to identify the traffic sign.

### RELATED APPLICATION

This application claims the benefit of U.S. Provisional Patent Application 61/053,333 filed May 15, 2008, which is incorporated herein by reference.

### TECHNICAL FIELD

The present invention relates generally to wireless communications devices, and particularly to camera-equipped wireless communication devices.

### BACKGROUND

In many instances, people that travel to other countries are confused by that country's traffic signs. This can be especially true for travelers who do not understand the local language or laws, and can be particularly troublesome for automobile drivers trying to navigate to a desired destination. It would be helpful to such people to be able to translate an unfamiliar road or traffic sign to a more familiar counterpart very quickly. Being able to understand a given road or traffic sign could help a person to determine what course of action to take and/or where to go even if that person does not fully understand the local language.

### SUMMARY

The present invention provides a camera-equipped wireless communication device that translates unfamiliar traffic signs for a user. Such signs include traffic signs posted in foreign countries, for example.

In one embodiment, the camera-equipped device captures an image of a traffic sign. A processor in the device performs image recognition techniques on the captured image, and then outputs information based on the analysis that identifies the traffic sign for the user. In one embodiment, the device includes a local database that stores artifacts and features of different traffic signs that the user may encounter. For each traffic sign, the database also stores corresponding information that identifies or explains the traffic sign. The information may be, for example, an image of a corresponding traffic sign that the user is familiar with, or an audio file that audibly identifies the traffic sign for the user.

To translate the traffic sign in the image, the processor may process the image to generate the artifacts or features about the traffic sign according to any known image processing scheme. The processor can then compare those results to the artifacts stored in the database. If a match is found, the processor retrieves the corresponding information that identifies or explains the traffic sign and outputs it for the user.

In one exemplary embodiment, the device comprises a memory. The memory is configured to store data representing a plurality of traffic signs as well as the information that identifies or explains the traffic sign and outputs it to the user.

In one exemplary embodiment, the processor determines the current geographical location of the device and uses that information to compare the captured image of the traffic sign to the data stored in the memory. If a match is found, the processor retrieves the identifying information.

In one exemplary embodiment, the information associated with the translated traffic sign is an image of a traffic sign that is familiar to the user. The image is displayed to the user on a display so that the user can identify the unfamiliar traffic sign.

In another exemplary embodiment, the information associated with the translated traffic sign comprises an audio file. The audio file is rendered to the user so that the user can identify the unfamiliar traffic sign.

In one exemplary embodiment, the device includes a short-range interface that allows the device to establish a corresponding short-range communication link with a vehicle. The processor may send the information associated with the translated traffic sign to the vehicle so that the vehicle can output the received information to a Heads-Up Display (HUD) or to another output screen or set of loudspeakers.

In one exemplary embodiment, the device lacks a sufficient amount of resources or cannot locate the desired traffic sign in the database. Therefore, the processor can generate a translation request message to include the captured image of the traffic sign. Once generated, a cellular transceiver transmits the translation request message to a network server.

In one exemplary embodiment, the camera-equipped device also comprises a transceiver. The transceiver is configured to receive the translation information from the network server.

In addition to the camera-equipped device, the present invention also provides a method of identifying unfamiliar traffic signs. Particularly, the method includes capturing an image of a traffic sign using the camera associated with the wireless communication device, translating the traffic sign in the captured image to generate information about the traffic sign, and outputting the translation information to the user so that the user can identify the traffic sign.

In one exemplary method, the device stores data representing a set of unfamiliar traffic signs. For each sign, the device also stores translation information associated with a corresponding traffic sign that is familiar to the user.

In one exemplary method, the device determines its current location and compares the captured image of the traffic sign to the data representing the traffic sign stored in the memory based on the current location. If found, the retrieving the information associated with the data if a match is found.

In one exemplary method, outputting translation information to the user comprises displaying an image of a traffic sign that is familiar to the user.

In one exemplary method, outputting translation information to the user comprises rendering an audio file identifying the traffic sign in the captured image to the user.

In one exemplary method, outputting translation information comprises sending the translated information to an output device associated with a vehicle via a short-range communication link established between the camera-equipped wireless communication device and the vehicle.

In one exemplary method, translating the traffic sign in the captured image comprises generating a translation request message to include the captured image of the traffic sign, transmitting the translation request message to a network server, and receiving the translated information from the network server.

### BRIEF DESCRIPTION OF THE DRAWINGS

FIG. 1 is a block diagram illustrating some of the component parts of a camera-equipped wireless communication device configured according to one embodiment of the present invention.

FIG. 2 is a perspective view of a camera-equipped wireless communication device configured according to one embodiment of the present invention.

FIG. 3 is a perspective view of a traffic sign that is familiar to the user in one embodiment of the present invention.

FIG. 4 is a perspective view of a traffic sign that is unfamiliar to the user in one embodiment of the present invention.

FIG. 5 is a flow chart illustrating a method of determining the meaning of an unfamiliar traffic sign for a user according to one embodiment of the present invention.

FIG. 6 illustrates a communication network suitable for use in one embodiment of the present invention.

FIG. 7 is a flow chart illustrating another method of determining the meaning of an unfamiliar traffic sign for a user according to another embodiment of the present invention.

### DETAILED DESCRIPTION

The present invention provides a camera-equipped wireless communication device that translates unfamiliar objects, such as road or traffic signs, for a user. Exemplary signs include, but are not limited to, signs in foreign countries that may or may not be labeled with text in a language that the user cannot understand.

In one embodiment, the device, is mounted on the interior of a user's vehicle and captures a digital image of an unfamiliar traffic sign. The device also periodically determines its geographic location. Based on this location, the wireless communication device searches a database to obtain information associated with the unfamiliar traffic sign for the user. For example, the device may be configured to compare artifacts associated with the captured image to artifacts associated with the traffic signs stored in the database. If a match occurs, the wireless communication device retrieves information associated with the traffic sign in the captured image and renders it to the user. The information may comprise an image of a corresponding traffic sign that the user would recognize, or an audio file in the user's native language explaining the meaning of the unfamiliar traffic sign.

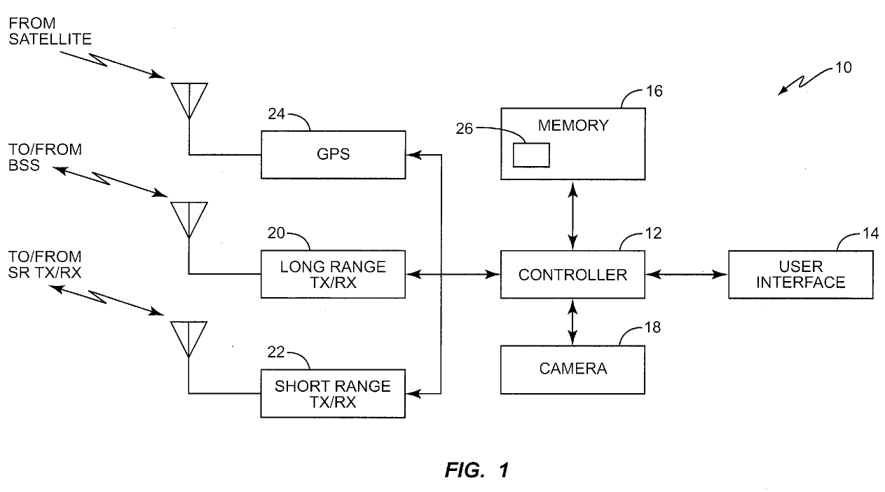

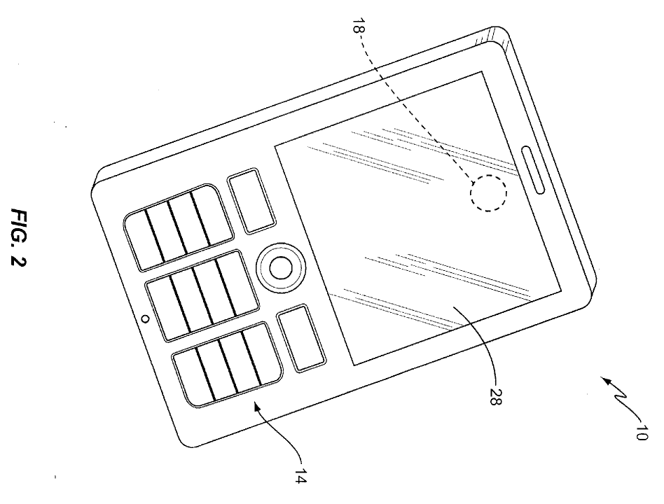

Turning now to the figures, the wireless communication device may be, for example, a camera-equipped cellular telephone 10 such as the one seen in FIGS. 1 and 2. Cellular telephone 10 typically includes a controller 12, a User Interface (UI) 14, memory 16, a camera 18, a long-range transceiver 20, and a short-range transceiver 22. In some embodiments, cellular telephone 10 may also include a Global Positioning Satellite (GPS) receiver 24 to permit cellular telephone 10 to identify its current geographical location.

The controller 12, which may be a microprocessor, controls the operation of the cellular telephone 10 based on application programs and data stored in memory 16. The control functions may be implemented in a single digital signal microprocessor, or in multiple digital signal microprocessors. In one embodiment of the present invention, controller 12 generates control signals to cause the camera 18 to capture an image of a road or traffic sign, such as a road sign that the user finds unfamiliar or cannot understand because it's text is in a foreign language. The controller 12 then analyzes the image to extract data indicative of the sign, and compares that data to data stored in a local database 26. The data in the database 26 represents signs unfamiliar to the user. Each points to a corresponding image of a road sign that is familiar to the user. The controller 12 retrieves the corresponding familiar image and outputs it to a display 28 for the user.

The UI 14 facilitates user interaction with the cellular telephone 10. For example, via the UI 14, the user can control the communication functions of cellular telephone 10, as well as the camera 18 to capture images. The user may also use the UI 14 to navigate menu systems and to selectively pan through multiple captured images stored in memory 16. The UI 14 also comprises the display 28 that allows the user to view the corresponding familiar road sign images retrieved from database 26. In addition, display 28 may also function as a viewfinder when capturing images.

Memory 16 represents the entire hierarchy of memory in the cellular telephone 10, and may include both random access memory (RAM) and read-only memory (ROM). Computer program instructions and data required for operation are stored in non-volatile memory, such as EPROM, EEPROM, and/or flash memory, while data such as captured images, video, and the metadata used to annotate them are stored in volatile memory. As previously stated, the memory 16 includes the database 26 that stores the data representing unfamiliar road signs and their corresponding familiar counterpart images.

The camera 18 may be any camera known in the art that is configured to capture digital images and video. It is well-known how such cameras 18 function, but for the sake of completeness, a brief description is included herein.

The camera 18 typically has a lens assembly that collects and focuses light onto an image sensor. The image sensor captures the light and may be a charge-coupled device (CCD), a complementary metal oxide semiconductor (CMOS) image sensor, or any other image sensor known in the art. Generally, the image sensor forwards the captured light to an image processor for image processing, which then forwards the image data for subsequent storage in memory 16, or to the controller 12. The controller 12 then analyzes the processed image data for translation into a more familiar image for display the user. It should be noted that in some embodiments, the image sensor may forward the captured light directly to controller 12 for processing and translation into a more familiar image for display the user.

The long-range and short-range communication interfaces 20, 22 allow the user to communicate voice and/or data with remote parties and entities. The long-range communication interface 20 may be, for example, a cellular radio transceiver configured that permits the user to engage in the voice and/or data communications over long distances via a wireless communication network. Such communication networks include, but are not limited to, Wideband Code Division Multiple Access (WCDMA) and Global System for Mobile communications (GSM) networks. The short-range interface 24 provides an air interface for communicating voice and/or data over relatively short-distances via wireless local area networks such as WiFi and BLUETOOTH networks.

Some embodiments of the present invention utilize the information provided by the GPS receiver 24. The GPS receiver 24 enables the cellular telephone 10 to determine its geographical location based on GPS signals received from a plurality of GPS satellites orbiting the earth. These satellites include, for example, the U.S. Global Positioning System (GPS) or NAVSTAR satellites; however, other systems are also suitable. Generally, the GPS receiver 24 is able to determine the location of the cellular telephone 10 by computing the relative time of arrival of signals transmitted simultaneously from the satellites. As described later in more detail, controller 12 may use the location information calculated by the GPS receiver 24 to analyze a captured image of an unfamiliar road sign.

As previously stated, people that travel to other countries are often times confused by that country's traffic signs. This is generally due to the differences in traffic sign design, and in some instances, differences in the traffic laws. These differences can be particularly stressful for people that are able to drive a car in a foreign country, but are not able to speak that country's language. Some traffic signs are self-explanatory and are, more or less, universally understood all drivers. One example of such a sign is a STOP sign. Other traffic signs, however, are not so universally understood and thus, require translation.

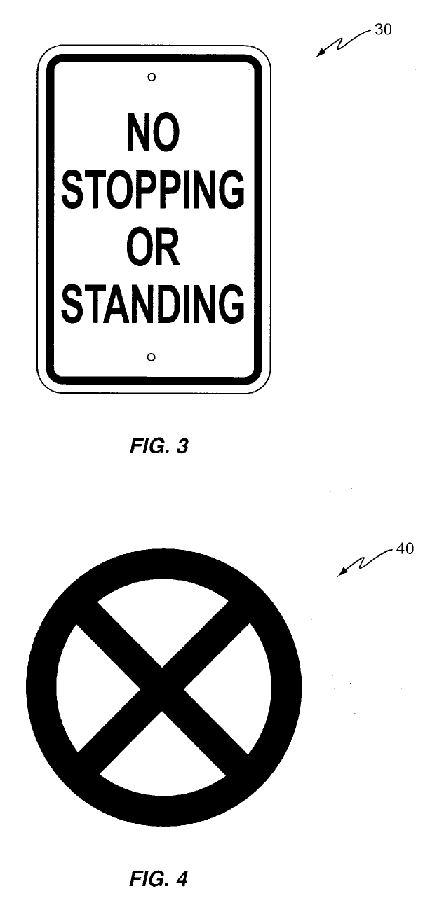

FIGS. 3 and 4, for example, illustrate two different traffic signs. Each provides the same command to a driver, but do so using very different designs. More specifically, FIG. 3 illustrates a “NO STOPPING OR STANDING” traffic sign 30 typically seen in the U.S. As is known in the art, the U.S. traffic sign 30 comprises a rectangular white, reflective background and large red, reflective block letters that spell out the sign content in the English language. For an English-speaking driver, there is no question that traffic sign 30 provides that stopping a vehicle, even temporarily, is prohibited. Non-English speaking tourists, however, would have a problem.

FIG. 4 illustrates a type of “NO STOPPING OR STANDING” traffic sign 40 typically found in European countries such as Germany. The German traffic sign 40 comprises only a red, reflective “X” inside of a red, reflective border over a blue reflective background. The German traffic sign 40 also prohibits a driver from stopping a vehicle at a designated spot, even temporarily. German and European drivers would certainly understand this sign. Americans driving through the country would not.

Traffic signs 30 and 40 are so different from one another that traffic sign 40 might confuse a non-German speaking driver traveling in Germany. Similarly, a non-English speaking driver might become confused upon seeing traffic sign 30 while driving in the U.S. The present invention addresses such confusion by utilizing the camera functionality in a person's cellular telephone. Particularly, the cellular telephone 10 captures images of unfamiliar traffic signs and compares them to traffic data stored in a database. If the data for an unfamiliar traffic sign is found in the database, the present invention displays an image of a corresponding traffic sign that the person would be more familiar with. This could help a person determine what to do or where to go regardless of the person's inability to speak the native language.

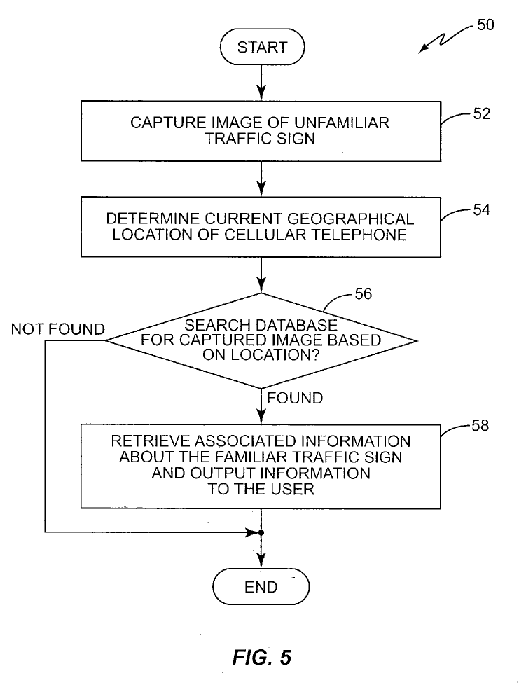

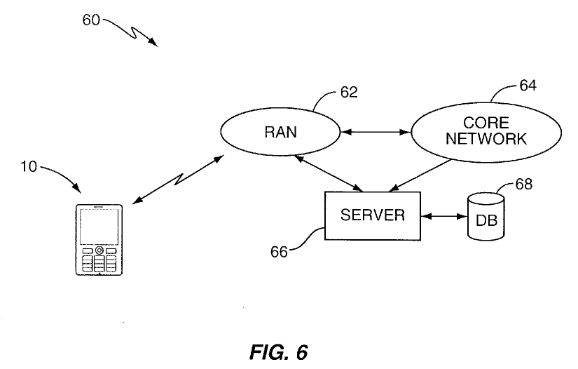

FIG. 5 illustrates an exemplary method 50 by which controller 12 analyzes the captured image of an unfamiliar traffic sign for translation to a driver. For illustrative purposes only, the following description is given in the context of a driver that is familiar with traffic sign 30, but unfamiliar with traffic sign 40.

Method 50 assumes that the cellular telephone 10 is mounted in the person's vehicle at a suitable angle such that the camera 18 can capture images of various traffic signs, such as sign 40. Method 50 begins when the controller 12 generates a signal to activate camera 18 to capture an image of traffic sign 40 (box 52). For example, the controller 12 may generate this signal automatically responsive to recognizing that a traffic sign is proximate the vehicle. In such cases, the controller 12 could execute any known image-recognition software package to detect that a traffic sign is present. Alternatively, the controller 12 may generate the signal responsive to detecting an input command, such as a voice or key command, from the user.

Regardless of how the controller captures the image of the traffic sign 40, the GPS receiver 24 will also provide the geographical coordinates of cellular telephone 10 to the controller 12 (box 54). The controller 12 will then search the database 26 for the traffic sign in the captured image based on the known geographical location of the cellular telephone 10, and on information gleaned from the captured image (box 56). For example, the database 26 may include information about traffic signs from all over the world. Knowing the geographical location of the cellular telephone 10 allows the controller 12 to limit the search to a set of traffic signs associated with a particular country or region. Once the controller 12 identifies a possible region or country, it could then process the captured image using any known object image-recognition technique to obtain distinguishing characteristics or features for that traffic sign.

By way of example, controller 12 (or the image processor) may analyze the captured image to determine various features or artifacts of traffic sign 40 using any well-known image processing technique. The output of the selected technique can then be compared to artifacts and features stored in database 26. If a match is found (box 56), the controller 12 retrieves information associated with the located artifacts and outputs the information for the user (box 58).

The information that is associated with the captured image of the unfamiliar road sign may be any type desired. In one embodiment, for example, the information that is associated with the traffic sign 40 comprises an image of traffic sign 30. In this case, the controller 12 could output the image of traffic sign 30 to the display 28 upon locating traffic sign 40 in the database 26. Alternatively, the information associated with traffic sign 40 may be an audio file that, when invoked by controller 12, renders an audible “NO STOPPING OR STANDING” sound byte to the user. In other embodiments, the information may comprise text that is output to display 28, or may comprise a combination of any of these pieces of information.

Although the cellular telephone 10 may include the necessary output devices (e.g., display, speaker, etc.) to render the meaning of the traffic sign 40 to the user, the present invention is not limited solely to the use of those output devices. In another embodiment, the controller 12 transmits the information retrieved from the database 26 to the user's vehicle via the short-range interface 24. In such cases, the user's vehicle would also be equipped with a corresponding short-range interface, such as a BLUETOOTH transceiver or appropriate cabling, to communicate with cellular telephone 10 and receive the information. Once received, the vehicle could employ known methods and functions to output the information for the user. By way of example, the vehicle may comprise the functions necessary to output an image of traffic sign 30, or text explaining the meaning of the unfamiliar sign, to a heads-up display (HUD) associated with the vehicle, or to an in-vehicle navigation system display. Similarly, received audio files may be rendered over the vehicle's speaker system.

In some cases, the cellular telephone 10 might not have the memory resources available to store or maintain information for all possible traffic signs. Therefore, in one embodiment, cellular telephone 10 transfers the captured images of unfamiliar traffic signs to an external server where processing may be accomplished. One exemplary system 60 used to facilitate this function is shown in FIG. 6.

As seen in FIG. 6, system 60 comprises a Radio Access Network (RAN) 62 and a Core Network (CN) 64. The operation of RAN 62 and CN 64 is well-known in the art. Therefore, no detailed discussion describing these networks is required. It is sufficient to understand that the cellular telephone 10, as well as other wireless communication devices not specifically shown in the figures, may communicate with one or more remote parties via system 60.

Cellular telephone 10 communicates with RAN 62 according to any of a variety of known air interface protocols. In some embodiments, RAN 62 connects to, or includes, a server 66 connected to a database (DB) 68. In other embodiments, however, CN 64 may interconnect the RAN 62 to server 66 and DB 68. Although not specifically shown here, CN 64 may also interconnect RAN 62 to other networks such as other RANs, the Public Switched Telephone Network (PSTN), and/or the Integrated Services Digital Network (ISDN).

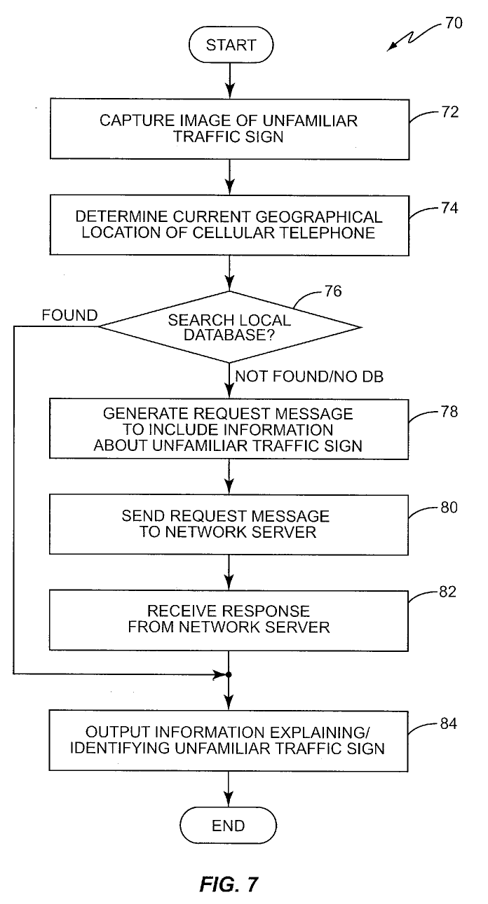

Server 66 provides a front-end to the data stored in DB 68. Such a server may be used, for example, where the cellular telephone 10 does not have the resources available to maintain a complete database of traffic signs according to the present invention. In such cases, as seen in method 70 of FIG. 7, the server 66 could download an image or other information explaining the meaning of an unfamiliar sign to the cellular telephone 10 via RAN 92 and/or CN 94.

In more detail, method 70 begins with the cellular telephone 10 capturing the image of an unfamiliar traffic sign (e.g., traffic sign 40) and determining it's current geographical location as previously described (boxes 72, 74). If the controller 12 locates the traffic sign 40 in its local database 26 (box 76), controller 12 will output information explaining or identifying the traffic sign to the user as previously described (box 84). If the controller 12 cannot find the unfamiliar traffic sign in the local database 26, or if cellular telephone 10 does not have a database 26 (box 76), controller 26 will generate a request message (box 78). The request message will generally comprise the captured image of the unfamiliar traffic sign 40, but may also include other information such as the current geographical location of the cellular telephone 10 and a language or country preference of the user. The controller 12 then transmits the request message to the server 66 via RAN 62 (box 80).

Upon receipt, server 66 searches the DB 68 for the traffic sign 40. If found, the server 66 retrieves the corresponding information and sends it to the requesting cellular telephone in a response message (box 82). The response message may include an image of a corresponding traffic sign that is familiar to the user of cellular telephone 10 (e.g., traffic sign 30), or may include an audio file that, when rendered, explains the meaning of the traffic sign 40 in the user's preferred language. The cellular telephone 10 may then display or render the received information to the user as previously described (box 84).

In this embodiment, the server 66 retrieves the information associated with the unfamiliar traffic sign 40 according to the user's preferences. For example, the DB 68 may store a plurality of traffic signs. However, the server 66 could be configured to retrieve only the information that the user would understand or be familiar with. For example, for an American driver traveling through Germany, the server 66 might retrieve an image of traffic sign 30 responsive to the request, or send the driver an audio file in the English language, based on the user's preferences.

Although user preferences may be helpful to server 66, those skilled in the art will readily appreciate that it is not necessary for cellular telephone 10 to determine and send its geographical location to server 66. Server 66 and DB 68 will typically have greater pools of available resources than cellular telephone 10, and therefore, are able to store and maintain a much larger, more complete database of information. Further, because the base stations in RAN 62 are fixed, server 66 may search for the unfamiliar traffic sign based on the location of the base station. Additionally, the cellular telephone 10 does not require GPS 24 to determine its own location. As is known in the art, cellular telephone 10 may also determine its current position using network 60.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A camera-equipped wireless communication device comprising:
a camera configured to capture an image of a traffic sign;
a processor configured to analyze the captured image to generate information about the traffic sign; and
an output device to output the information so that the user can identify the traffic sign.

2. The device of claim 1 further comprising a memory configured to store data representing the traffic sign and corresponding information associated with a traffic sign that is familiar to the user.

3. The device of claim 2 wherein the processor is further configured to:
compare the generated information to the data representing the traffic sign stored in the memory based on a current location of the device; and
retrieve the corresponding information associated with the data if a match is found.

4. The device of claim 2 wherein the corresponding information comprises an image of a traffic sign that is familiar to the user, and wherein the output device displays the image to the user.

5. The device of claim 2 wherein the corresponding information comprises an audio file, and wherein the output device renders the audio file as audible sound to the user.

6. The device of claim 2 further comprising a short-range interface to establish a short-range communication link with a vehicle, and wherein the processor is further configured to send the corresponding information to the vehicle for output to the user.

7. The device of claim 1 wherein the processor is configured to generate a translation request message to include the captured image of the traffic sign, and further comprising a cellular transceiver to transmit the translation request message to a network server.

8. The device of claim 7 wherein the transceiver is configured to receive the information associated with the traffic sign from the network server.

9. A method of translating traffic signs for a user of a camera-equipped wireless communication device, the method comprising:
capturing an image of a first traffic sign using a camera associated with a wireless communication device, wherein the first traffic sign is unfamiliar to a user;
analyzing the captured image to generate information about the first traffic sign; and
outputting the information corresponding to a second traffic sign that is familiar to the user so that the user can identify the first traffic sign.

10. The method of claim 9 further comprising storing data representing the first traffic sign, and the second traffic sign, in memory.

11. The method of claim 10 wherein analyzing the traffic sign in the captured image comprises:
determining a current location for the camera-equipped wireless communication device;
comparing the generated information to the data representing the first traffic sign stored in the memory based on the current location; and
retrieving the data corresponding to the second traffic sign if a match is found.

12. The method of claim 9 wherein outputting the information to the user comprises displaying an image of a traffic sign that is familiar to the user.

13. The method of claim 9 wherein outputting the information to the user comprises rendering an audio file identifying the traffic sign in the captured image to the user.

14. The method of claim 9 wherein outputting the information to the user comprises sending the information to an output device associated with a vehicle via a short-range communication link established between the camera-equipped wireless communication device and the vehicle.

15. The method of claim 9 wherein analyzing the traffic sign in the captured image comprises:
generating a translation request message to include the captured image of the traffic sign;
transmitting the translation request message to a network server; and
receiving the information corresponding to the second traffic sign from the network server.
